(19) United States
(12) Patent Application Publication
(10) Pub. No.: US 2019/0071781 A1
(43) Pub. Date: Mar. 7, 2019

(54) COATING FORMATION COMPOSITION AND METAL MATERIAL TREATMENT METHOD

(71) Applicant: OKUNO CHEMICAL INDUSTRIES CO., LTD., Osaka-shi, Osaka (JP)

(72) Inventors: Koichiro Murahashi, Osaka-shi (JP); Katsumasa Shimahashi, Osaka-shi (JP); Masafumi Nozaki, Osaka-shi (JP); Teruhiko Kagehisa, Osaka-shi (JP)

(73) Assignee: OKUNO CHEMICAL INDUSTRIES CO., LTD., Osaka-shi, Osaka (JP)

(21) Appl. No.: 16/084,483

(22) PCT Filed: Aug. 16, 2016
(86) PCT No.: PCT/JP2016/073891

§ 371 Date: Sep. 12, 2018

(30) Foreign Application Priority Data
Mar. 22, 2016 (JP) 2016-057629

(51) Int. Cl. C23C 22/53; C23C 22/78; C23C 22/76; C09D 183/04; C09D 7/61; C08K 3/30; C08K 3/36

(52) U.S. Cl. CPC C23C 22/53; C23C 22/78; C23C 22/76; C09D 183/04; C08K 2003/3045; C08K 3/30; C08K 3/36; C23C 2222/20; C09D 7/61

(57) ABSTRACT

This invention relates to a coating formation composition and a metal material treatment method that are capable of forming a laminate coating in which a chemical conversion coating and a surface treatment coating are laminated by applying and heating the composition on the surface of the metal material, without performing a chemical conversion treatment on the metal material separately from the surface treatment, and that are capable of imparting excellent rust prevention properties to the metal material. The invention provides a coating formation composition comprising an alkoxysilane oligomer, a metal salt, and a solvent, the solvent being water and/or a water-soluble organic solvent, and the metal salt being contained in an amount of 0.1 to 30 parts by mass per 100 parts by mass of the alkoxysilane oligomer.

### TECHNICAL FIELD

The present invention relates to a coating formation composition and a metal material treatment method.

### BACKGROUND ART

Chemical conversion using a chromic acid aqueous solution etc. or chromium-free surface treatment has been performed as a method for preventing rust of various metal materials such as zinc, aluminium, magnesium, and alloys thereof (for example, see Patent Literature 1 to 7).

However, it is difficult to perform chemical conversion on a metal material having difficulty in forming a chemical conversion coating, such as molten zinc, and sufficient rust prevention properties cannot be attained.

There is also another problem that when a chemical conversion coating or a coating formed by a chromium-free surface treatment is made of a single layer, its rust prevention properties are insufficient. Although metal materials have required higher rust prevention properties in recent years, the treatment methods mentioned above cannot attain sufficient rust prevention properties.

To improve rust prevention properties, one example may be performing chemical conversion to form a chemical conversion coating, and then separately performing a chromium-free surface treatment, thus forming the chemical conversion coating and a surface treatment coating; however, the chemical conversion and surface treatment must be performed in different steps, resulting in a complicated process and high cost.

Accordingly, there is a demand for the development of a coating formation composition and a metal material treatment method capable of forming a laminate coating in which a chemical conversion coating and a surface treatment coating are laminated by applying and heating the composition on the surface of the metal material, without performing a chemical conversion treatment on the metal material separately from the surface treatment, and imparting rust prevention properties to the metal material.

### CITATION LIST

### Patent Literature

PTL 1: JP2000-234177A

PTL 2: JP2003-166075A

PTL 3: JP2005-264170A

PTL 4: JP2006-225761A

PTL 5: JP2009-270137A

PTL 6: JP2010-174367A

PTL 7: JP2015-134942A

### SUMMARY OF INVENTION

### Technical Problem

An object of the present invention is to provide a coating formation composition and a metal material treatment method that are capable of forming a laminate coating in which a chemical conversion coating and a surface treatment coating are laminated by applying and heating the composition on the surface of the metal material, without performing a chemical conversion treatment on the metal material separately from the surface treatment. The composition and method of the present invention can also impart excellent rust prevention properties to the metal material.

### Solution to Problem

As a result of extensive research, the inventors found that the above object can be achieved by a coating formation composition comprising an alkoxysilane oligomer, a metal salt, and a solvent, wherein the solvent is water and/or a water-soluble organic solvent, and the metal salt is contained in an amount of 0.1 to 30 parts by mass per 100 parts by mass of the alkoxysilane oligomer. The inventors thus accomplished the present invention.

Specifically, the present invention relates to a coating formation composition and a metal material treatment method shown below.

Item 1. A coating formation composition comprising an alkoxysilane oligomer, a metal salt, and a solvent, the solvent being water and/or a water-soluble organic solvent, and the metal salt being contained in an amount of 0.1 to 30 parts by mass per 100 parts by mass of the alkoxysilane oligomer.

Item 2. The composition according to Item 1, wherein the metal salt is a salt of at least one metal selected from the group consisting of Cr, Ti, Zr, Sr, V, W, Mo, and Ce.

Item 3. The composition according to Item 1 or 2, further comprising a lubricant.

Item 4. The composition according to any one of Items 1 to 3, further comprising colloidal silica.

Item 5. The composition according to any one of Items 1 to 4, further comprising water glass.

Item 6. The composition according to any one of Items 1 to 5, wherein the composition is a coating formation composition of a laminate coating including a chemical conversion coating and a siliceous coating.

Item 7. A metal material treatment method comprising:

(1) step 1 of applying a coating formation composition to a surface of the metal material to form a coating formation composition layer, and

(2) step 2 of heating the coating formation composition layer to form on the surface of the metal material a laminate coating including a chemical conversion coating and a siliceous coating in this order from the side of the metal material,

the coating formation composition comprising an alkoxysilane oligomer, a metal salt, and a solvent,

the solvent being water and/or a water-soluble organic solvent, and

the metal salt being contained in an amount of 0.1 to 30 parts by mass per 100 parts by mass of the alkoxysilane oligomer.

Item 8. The method according to Item 7, wherein the metal material is zinc or zinc alloy, and the surface of the metal material is treated with a blackening treatment solution free of chromium, cobalt, or nickel.

Item 9. The method according to Item 7 or 8, wherein the coating formation composition is prepared by a sol-gel method.

### Advantageous Effects of Invention

The coating formation composition of the present invention enables the formation of a laminate coating in which a chemical conversion coating and a surface treatment coating are laminated by applying and heating the composition on the surface of a metal material, without performing a chemical conversion treatment on the metal material separately from the surface treatment, and imparting excellent rust prevention properties to the metal material. Further, according to the metal material treatment method of the present invention, a laminate coating in which a chemical conversion coating and a surface treatment coating are laminated can be simultaneously formed by merely applying and heating the coating formation composition on the surface of the metal material without separately performing a chemical conversion treatment, and excellent rust prevention properties can be imparted to the metal material.

### BRIEF DESCRIPTION OF DRAWINGS

FIG. 1 is an FE-SEM photograph showing the section of a galvanized steel plate and a laminate coating formed on the plate in Example 1.

FIG. 2 is a graph showing the results of GDS analysis of the galvanized steel plate and the laminate coating formed on the plate in Example 1.

### DESCRIPTION OF EMBODIMENTS

### 1. Coating Formation Composition

The coating formation composition of the present invention comprises an alkoxysilane oligomer, a metal salt, and a solvent. The solvent is water and/or a water-soluble organic solvent, and the amount of the metal salt is 0.1 to 30 parts by mass per 100 parts by mass of the alkoxysilane oligomer. Since the coating formation composition having the above features of the present invention comprises an alkoxysilane oligomer and a metal salt in a solvent, which is water and/or a water-soluble organic solvent, a laminate coating including a chemical conversion coating and a siliceous coating in this order from the side of the metal material can be formed by applying and heating the composition on the surface of the metal material. Specifically, the laminate coating can be formed without performing a chemical conversion treatment on the metal material separately from the surface treatment.

Since the coating formation composition of the present invention contains the metal salt in an amount of 0.1 to 30 parts by mass per 100 parts by mass of the alkoxysilane oligomer, the chemical conversion coating and the siliceous coating can be sufficiently formed, and the generation of cracks on the coatings can be prevented, thus imparting excellent rust prevention properties to the metal material.

The coating formation composition of the present invention can form the laminate coating including a chemical conversion coating and a siliceous coating in this order from the side of the metal material without performing a chemical conversion treatment on the metal material separately from the surface treatment presumably because of the reason below.

Specifically, by heating the coating formation composition layer that is formed by applying the coating formation composition of the present invention on the surface of the metal material, the alkoxysilane oligomer forms a siloxane skeleton in the coating formation composition. By forming the coating formation composition layer on the surface of the metal material and heating the layer, the surface of the metal material becomes molten, and the pH at the interface of the metal material and the coating formation composition layer is raised to deposit a metal salt on the surface of the metal material. Thus, a chemical conversion coating of the metal salt is selectively formed on the surface of the metal material, and a siliceous coating is formed on the side opposite to the metal material side of the chemical conversion coating.

Presumably for the reason described above, use of the coating formation composition of the present invention enables the formation of the laminate coating having a chemical conversion coating and a siliceous coating in this order from the side of the metal material, without performing a chemical conversion treatment on the metal material separately from the surface treatment.

The present invention is explained in detail below.

### Alkoxysilane Oligomer

Examples of alkoxysilane oligomers are not limited, and usable examples include those prepared by adding alkoxysilane to water, alcohol, glycol, or glycol ether, and mixing a catalyst such as an acid, base, or organic metallic compound to perform hydrolysis and condensation reaction.

In the coating formation composition of the present invention, the alkoxysilane oligomer can be used as an alkoxysilane oligomer solution obtained by subjecting alkoxysilane to hydrolysis and condensation beforehand, adding the alkoxysilane condensate to a solvent, and mixing the resultant with a catalyst.

In the coating formation composition of the present invention, the alkoxysilane oligomer can be used as an alkoxysilane oligomer solution obtained by adding alkoxysilane, or alkoxysilane and an alkoxysilane low condensate to a solvent, and mixing the resultant with water and a catalyst. In this case, an alkoxysilane oligomer is produced by a sol-gel method in which hydrolysis and condensation reaction of alkoxysilane proceeds in an alkoxysilane oligomer solution.

The alkoxysilane mentioned above is, for example, represented by the formula (R¹)ₘSi(OR²)₄₋ₘ (wherein R¹ is a functional group, R² is a lower alkyl group, and m is an integer of 0 to 3). In the formula, examples of functional groups include vinyl, 3-glycidoxy propyl, 3-glycidoxy propylmethyl, 2-(3,4-epoxycyclohexyl)ethyl, p-styryl, 3-methacryloxypropyl, 3-methacryloxypropyl methyl, 3-acryloxyprophyl, 3-aminopropyl, N-2-(aminoethyl)-3-aminopropyl, N-2-(aminoethyl)-3-aminopropyl methyl, 3-triethoxysilyl-N-(1,3-dimethylbutylidene)propylamine, N-phenyl-3-aminopropyl, N-(vinylbenzyl)-2-aminoethyl-3-aminopropyl, tris(trimethoxysilylpropyl)isocyanurate, 3-ureidopropyl, 3-mercaptopropyl, 3-mercaptopropylmethyl, bis(triethoxysilylpropyl)tetrasulfide, 3-isocyanatepropyl, 3-propyl succinic anhydride, and the like.

Examples of lower alkyl groups include straight or branched alkyl groups having about 1 to 6 carbon atoms, such as methyl, ethyl, n-propyl, isopropyl, n-butyl, isobutyl, tert-butyl, sec-butyl, n-pentyl, 1-ethylpropyl, isopentyl, and neopentyl.

Examples of alkoxysilanes represented by the formula above include Si(OCH₃)₄, Si(OC₂H₅)₄, CH₃Si(OCH₃)₃, CH₃Si(OC₂H₅)₃, C₂H₅Si(OCH₃)₃, C₂H₅Si(OC₂H₅)₄, CHCH₂Si(OCH₃)₃, CH₂CHOCH₂O(CH₂)₃Si(CH₃O)₃, CH₂C(CH₃)COO(CH₂)₃Si(OCH₃)₃, CH₂CHCOO(CH₂)₃Si(OCH₃)₃, NH₂(CH₂)₃Si(OCH₃)₃, SH(CH₂)₃Si(CH₃)₃, NCO(CH₂)₃Si(C₂H₅O)₃, and the like.

Examples of catalysts include acids, bases, organic metal compounds, and the like.

Examples of acids include inorganic acids, such as hydrochloric acid, nitric acid, sulfuric acid, phosphoric acid, and boric acid; and organic acids, such as formic acid, acetic acid, citric acid, and oxalic acid.

Examples of bases include hydroxides of alkaline metals or alkaline earth metals, such as potassium hydroxide and sodium hydroxide; amine compounds, such as monoethyl amine and like primary amines, diethylamine and like secondary amines, and triethylamine and like tertiary amines, and ammonia.

Examples of organic metal compounds include water-soluble organic metal chelate compounds or metal alkoxides including metal components such as titanium, zirconium, aluminium, or tin.

Examples of organic metal chelate compounds include titanium chelate compounds, such as titanium diisopropoxy bisacetylacetonate, titanium tetra acetylacetonate, titanium dioctyloxybisethyl acetoacetonate, titanium octylene glycolate, titanium diisopropoxy bisethylacetylacetonate, titanium lactate, titanium lactate ammonium salt, and titanium diisopropoxy bistriethanolaminate; zirconium chelate compounds, such as zirconium tetra acetylacetonate, zirconium tributoxy monoacetyl acetonate, zirconium dibutoxy bisethylacetoacetate, and zirconium tributoxy monostearate; aluminum chelate compounds, such as ethylacetoacetate aluminum diisopropylate, aluminum tris ethyl acetate, alkyl acetoacetate aluminum diisopropylate, and aluminum monoacetylacetonate bisethylacetoacetate; and the like.

Examples of metal alkoxides include titanium alkoxide compounds, such as tetraisopropyl titanate, tetranormalbutyl titanate, butyl titanate dimer, tetra tertiary butyl titanate, and tetraoctyl titanate; zirconium alkoxide compounds, such as normal propyl zirconate and normal butyl zirconate; aluminum alkoxide compounds, such as aluminum isopropylate, monobutoxy aluminum diisopropylate, and aluminum butyrate; and the like.

The catalysts may be used alone or in a combination of two or more.

The amount of the catalyst is not limited, and it is preferably 0.01 to 20 mass %, and more preferably 0.1 to 10 mass %, per 100 mass % of the coating formation composition of the present invention.

The polymerization degree of the alkoxysilane oligomer is not limited, and it is preferably 1000 to 10000. Although hydrolysis and condensation reaction of alkoxysilane proceed in the coating formation composition of the present invention, the reaction preferably does not prevent smooth coating on the surface of the metal material. By setting the polymerization degree of the alkoxysilane oligomer to the above range, the coating formation composition of the present invention is easily applied to the surface of the metal material.

The amount of the alkoxysilane oligomer in the alkoxysilane oligomer solution is preferably 1 to 50 mass %, and more preferably 10 to 40 mass %, per 100 mass % of the alkoxysilane oligomer solution. The siliceous coating can be sufficiently formed when the amount of the alkoxysilane oligomer in the alkoxysilane oligomer solution is within the above range.

The amount of the alkoxysilane oligomer in the coating formation composition of the present invention is preferably 0.5 to 45 mass %, and more preferably 10 to 35 mass %, per 100 mass % of the coating formation composition. The siliceous coating can be sufficiently formed when the amount of the alkoxysilane oligomer in the coating formation composition is within the above range.

### Metal Salt

Examples of metal salts are not limited, and conventionally known metal salts can be used. Examples of such metal salts include metal salts of Cr, Ti, Zr, Sr, V, W, Mo, or Ce.

Examples of metal salts of Cr include chromium sulfate, chromium nitrate, chromium acetate, dichromate, and the like. Examples of metal salts of Ti include titanium chloride, titanium sulfate, and the like. Examples of metal salts of Zr include zirconyl salts, such as zirconyl sulfate and zirconium oxychloride; and zirconium salts, such as Zr(SO₄)₂ and Zr(NO₃)₂. Examples of metal salts of Sr include strontium chloride, strontium peroxide, strontium nitrate, and the like. Examples of metal salts of V include vanadates, such as ammonium vanadate and sodium vanadate; oxyvanadates, such as vanadium oxynitrate; and the like. Examples of metal salts of W include tungstates, such as ammonium tungstate and sodium tungstate; and the like. Examples of metal salts of Mo include molybdates, such as ammonium molybdate and sodium molybdate; molybdophosphates, such as sodium molybdophosphate, and the like. Examples of metal salts of Ce include cerium chloride, cerium sulfate, cerium perchlorate, cerium phosphate, cerium nitrate, and the like.

The metal salts can be used alone or in a combination of two or more.

The amount of the metal salt in the coating formation composition is 0.1 to 30 parts by mass per 100 parts by mass of the alkoxysilane oligomer. When the amount of the metal salt is less than 0.1 parts by mass, the chemical conversion coating and the siliceous coating are not sufficiently formed, resulting in poor rust prevention properties. When the amount of the metal salt exceeds 30 parts by mass, cracks occur on the chemical conversion coating and the siliceous coating, resulting in poor rust prevention properties. The amount of the metal salt is preferably 10 to 25 parts by mass.

### Solvent

The coating formation composition of the present invention contains water and/or a water-soluble organic solvent as a solvent. When water is used alone as a solvent, the coating formation composition preferably has a pH of 1 to 5, and more preferably 2 to 4. The coating formation composition having a pH within the above range can exhibit excellent stability when water is used as a solvent.

The water-soluble organic solvent is not limited, and conventionally known water-soluble organic solvents can be used. Examples of such water-soluble organic solvents include alcohol-based solvents, glycol-based solvents, glycol ether-based solvents, ether alcohol-based solvents, and the like. Among these, propylene glycol and propylene glycol monomethyl ether are preferable in view of excellent compatibility with water.

Water and the water-soluble organic solvents can be used alone or in a combination of two or more.

The amount of the solvent in the coating formation composition of the present invention is preferably 50 to 95 mass %, and more preferably 60 to 85 mass %, per 100 mass % of the coating formation composition. When the amount of the solvent in the coating formation composition is within the above range, excellent coating-forming properties can be attained.

### Lubricant

The coating formation composition of the present invention may comprise a lubricant. Containing a lubricant is effective because moderate lubricity can be imparted to a sliding surface of a bolt, nut, etc., when a coating is formed on the sliding surface.

Examples of lubricants include fine powdery waxes, such as amide wax, paraffin wax, carnauba wax, lanolin wax, polytetrafluoroethylene wax, polyethylene wax, and polypropylene wax; and dimethyl silicone oils, such as amino-modified dimethyl silicone oil, epoxy-modified dimethyl silicone oil, carbinol-modified dimethyl silicone oil, mercapto-modified dimethyl silicone oil, carboxyl-modified dimethyl silicone oil, methacryl-modified dimethyl silicone oil, acryl-modified dimethyl silicone oil, polyether-modified dimethyl silicone oil, phenol-modified dimethyl silicone oil, silanol-modified dimethyl silicone oil, carboxylic anhydride-modified dimethyl silicone oil, diol-modified dimethyl silicone oil, aralkyl-modified dimethyl silicone oil, fluoroalkyl-modified dimethyl silicone oil, long-chain alkyl-modified dimethyl silicone oil, higher fatty acid ester-modified dimethyl silicone oil, higher fatty acid-modified dimethyl silicone oil, and phenyl-modified dimethyl silicone oil.

The amount of the lubricant in the coating formation composition is preferably 0.5 to 30 parts by mass, and 1 to 20 parts by mass, per 100 parts by mass of the alkoxysilane oligomer solution. By setting the amount of the lubricant to the above range, a laminate coating including a chemical conversion coating and a siliceous coating is sufficiently formed, and sufficient lubricity can be imparted to the coating, which reduces the friction coefficient of the coating.

### Colloidal Silica

The coating formation composition of the present invention may comprise colloidal silica. Colloidal silica acts as an auxiliary for forming a coating, improves the rust prevention properties of the laminate coating formed by the coating formation composition of the present invention, and reduces sudden shrinkage of the laminate coating.

Colloidal silica is a dispersion in which spherical silica nanoparticles having a particle diameter of about 100 nm or less, or spherical silica nanoparticles in chains are dispersed in a solvent. Water-based colloidal silica in which water is used as a solvent, and solvent-based colloidal silica in which various organic solvents are used as solvents can be both used. Examples of water-based colloidal silica include alkaline colloidal silica and acidic colloidal silica, and both can be used; however, acidic colloidal silica is preferable to maintain stability of a liquid composition.

Examples of solvents of solvent-based colloidal silica include methanol, isopropanol, dimethylacetamide, ethylene glycol, ethylene glycol mono-n-propyl ether, ethylene glycol monoethyl ether, ethyl acetate, propyleneglycol monoethyl ether acetate, methyl ethyl ketone, methyl isobutyl ketone, toluene, propylene glycol, and the like. The amount of silica in the colloidal silica is not limited, and it is preferably about 5 to 40 mass % on a solids basis.

The amount of the colloidal silica in the coating formation composition of the present invention is preferably 2 to 60 parts by mass, and more preferably 5 to 50 parts by mass, on a solids basis, per 100 parts by mass of the alkoxysilane oligomer solution. The amount of the colloidal silica is preferably 1 to 50 mass %, and more preferably 2 to 40 mass %, on a solids basis, per 100 mass % of the coating formation composition.

### Water Glass

The coating formation composition of the present invention may comprise water glass. Water glass contained in the coating formation composition ensures a highly dense coating.

Water glass is not limited, and conventionally known water glass can be used. Examples of water glass include sodium silicate, potassium silicate, lithium silicate, and the like.

The amount of water glass in the coating formation composition of the present invention is preferably 1 to 50 mass %, and more preferably 2 to 40 mass %, per 100 mass % of the coating formation composition.

According to the coating formation composition of the present invention as explained above, without performing a chemical conversion treatment on the metal material separately from a surface treatment, a laminate coating in which a chemical conversion coating and a surface treatment coating are laminated in this order from the side of the metal material surface can be formed by only applying and heating the composition on the surface of the metal material, and rust prevention properties can be easily imparted to the metal material.

The laminate coating preferably has a thickness of 0.1 to 10 μm, and more preferably 0.5 to 5 μm. The laminate coating having a thickness within the above range enables imparting more excellent rust prevention properties and abrasion resistance to the surface of the metal material, without impairing the dimensional accuracy of the metal material.

In the laminate coating, the chemical conversion coating preferably has a thickness of 0.01 to 1 μm, and more preferably 0.1 to 1 μm. The chemical conversion coating having a thickness within the above range ensures excellent rust prevention properties.

In the laminate coating, the siliceous coating preferably has a thickness of 0.09 to 9 μm, and more preferably 0.4 to 4 μm. The siliceous coating having a thickness within the above range ensures more excellent rust prevention properties and abrasion resistance.

### Metal Material Treatment Method

The metal material treatment method of the present invention comprises the steps of (1) applying a coating formation composition on the surface of the metal material to form a coating formation composition layer (step 1), and (2) heating the coating formation composition layer to form on the surface of the metal material a laminate coating including a chemical conversion coating and a siliceous coating in this order from the side of the metal material (step 2). In this method, the coating formation composition comprises an alkoxysilane oligomer, a metal salt, and a solvent; the solvent is water and/or a water-soluble organic solvent; and the metal salt is contained in an amount 0.1 to 30 parts by mass per 100 parts by mass of the alkoxysilane oligomer

According to the treatment method of the present invention, by applying the coating composition on the surface of the metal material to form a coating formation composition layer in step 1, and by heating the coating formation composition layer in step 2, a laminate coating in which a chemical conversion coating and a surface treatment coating are laminated by applying and heating the composition on the surface of the metal material can be formed without performing a chemical conversion treatment on the metal material separately from the surface treatment, and rust prevention properties can be easily imparted to the metal material.

### Step 1

Step 1 is a step of applying a coating formation composition to the surface of a metal material to form a coating formation composition layer.

A subject to be treated by the treatment method of the present invention is a metal material. Various types of metal materials, such as zinc, aluminium, magnesium, cobalt, nickel, iron, copper, tin, gold, and alloys thereof can be used as subjects to be treated. Of these, molten zinc and zinc alloy have difficulty in forming a chemical conversion coating by conventional chemical conversion; however, a chemical conversion coating can be formed by the treatment method of the present invention. Thus, molten zinc and zinc alloy can also be preferably used as subjects to be treated.

The metal material is present on the surface of the subject to be treated so that the metal material can be sufficiently in contact with a treating agent. For example, an article consisting of the metal material mentioned above may be used, or a composite article of the metal material and other materials, such as ceramic materials or plastic materials, may be used. A metal-plated article on which a plating coating is formed on the surface using the metal mentioned above may be also used. For example, a steel plate on which zinc plating or zinc alloy plating is formed can be used as an object to be treated.

The metal material may be subjected to blackening treatment to impart decorativeness. In one example of blackening treatment, the metal material is immersed in a blackening treatment solution whose pH has been adjusted to the predetermined range using an inorganic acid and/or organic acid. In general, the rust prevention properties of the surface of the metal material tend to decrease after blackening treatment.

Specific examples of inorganic acids include hydrochloric acid, sulfuric acid, nitric acid, phosphoric acid, hydrofluoric acid, boric acid, and the like. Specific examples of organic acids include aliphatic monocarboxylic acids, such as formic acid and acetic acid; aliphatic dicarboxylic acids, such as oxalic acid, malonic acid, and succinic acid; aliphatic hydroxy monocarboxylic acids, such as gluconic acid; aliphatic hydroxy dicarboxylic acids, such as malic acid; aliphatic hydroxy tricarboxylic acids, such as citric acid; and carboxylic acids, such as thioglycolic acid. These inorganic acids and organic acids can be used alone or in a combination of two or more.

The surface of the metal material is preferably treated with a blackening treatment solution free of chromium, cobalt, or nickel. By treating the surface of the metal material with such a blackening treatment solution, the environmental burden is minimized; thus, the treatment method of the present invention can be preferably performed in Europe and other areas where use of such metals is restricted.

The solution temperature of the blackening treatment solution is preferably 10 to 80° C., and more preferably 30 to 60° C. The immersion time of the metal material is preferably 10 seconds to 20 minutes, and more preferably 30 seconds to 10 minutes.

The coating formation composition as explained above can be used as the coating formation composition used in step 1. In step 1, the coating formation composition is preferably prepared by a sol-gel method. Specifically, an alkoxysilane oligomer is preferably used as an alkoxysilane oligomer solution obtained by adding alkoxysilane, or alkoxysilane and a low condensate of alkoxysilane to a solvent, and mixing the resultant with water and a catalyst. In this case, hydrolysis and condensation reaction of the alkoxysilane proceed in the alkoxysilane oligomer solution to form an alkoxysilane oligomer.

Conventionally known methods can be used to apply the coating formation composition on the surface of the metal material. Examples of methods include a dip coating method, dip-spin coating method, spray coating method, roll coating method, spin coating method, bar coating method, and the like. Among these, a dip spin coating method and a spray coating method are preferable to ensure uniform coating regardless of the shape of the metal material.

By applying the coating formation composition according to the method mentioned above, a coating formation composition layer is formed on the surface of the metal material. The coating formation composition layer preferably has a thickness of 1 to 50 μm, and more preferably 5 to 30 μm. By setting the thickness of the coating formation composition layer to the above range, the thickness of the laminate coating formed in step 2 explained below can be adjusted to an appropriate range, and excellent rust prevention properties and abrasion resistance can be imparted to the surface of the metal material without impairing the dimensional accuracy of the metal material.

According to step 1 explained above, the coating formation composition is applied on the surface of the metal material to form a coating formation composition layer.

### Step 2

Step 2 is a step of heating the coating formation composition layer to form on the surface of the metal material a laminate coating including a chemical conversion coating and a siliceous coating in this order from the side of the metal material.

The method of heating the coating formation composition layer formed on the surface of the metal material is not limited, and heating is conducted by a conventionally known method. In one example, the metal material having the coating formation composition layer is introduced in a drier and maintained for a certain period of time for heating.

The heating temperature is generally preferably 20 to 200° C., more preferably 40 to 180° C., and even more preferably 60 to 150° C. The heat treatment time is preferably 30 seconds to 30 minutes, and more preferably 5 to 30 minutes.

When the normal temperature is around 20° C., a drier or the like is not required for heating in step 2, and the layer may be allowed to stand at normal temperature for a certain period of time.

According to step 2 as explained above, the laminate coating including a chemical conversion coating and a siliceous coating in this order from the side of the metal material is formed on the surface of the metal material.

The laminate coating preferably has a thickness of 0.1 to 10 μm, and more preferably 0.5 to 5 μm. The laminate coating having a thickness within the above range enables imparting excellent rust prevention properties and abrasion resistance to the surface of the metal material, without impairing the dimensional accuracy of the metal material.

In the laminate coating, the chemical conversion coating preferably has a thickness of 0.01 to 1 μm, and more preferably 0.1 to 1 μm. The chemical conversion coating having a thickness within the above range ensures excellent rust prevention properties.

In the laminate coating, the siliceous coating preferably has a thickness of 0.09 to 9 μm, and more preferably 0.4 to 4 μm. The siliceous coating having a thickness within the above range ensures excellent rust prevention properties and abrasion resistance.

### EXAMPLES

The present invention is detailed below with reference to Examples and Comparative Examples. However, the present invention is not limited to these.

### Example 1

### Preparation of Coating Formation Composition

An alkoxysilane oligomer solution having a composition shown in Table 1 was prepared. Specifically, 53.4 mass % of propylene glycol, and 30 mass % of alkoxysilane oligomer containing 15 mass % of tetramethoxy silane and 15 mass % of 3-mercaptopropyl silane, per 100 mass % of the alkoxysilane oligomer solution were mixed to prepare a mixture. Subsequently, 8.3 mass % of water and 8.3 mass % of titanium dioctyloxy bis octylene glycolate were added to the mixture, and 8.3 mass % of water was added thereto to perform hydrolysis and condensation polymerization, thus preparing an alkoxysilane oligomer solution.

Subsequently, 15 parts by mass of chromium sulfate per 100 parts by mass of the alkoxysilane oligomer in the solution was added to the alkoxysilane oligomer solution, and a colloidal silica propylene glycol dispersion (concentration of colloidal silica: 30 mass %) was added thereto so that the solids content of colloidal silica was 5 parts by mass per 100 parts by mass of the alkoxysilane oligomer solution, thus preparing a coating formation composition.

The coating formation composition thus prepared was then applied on a galvanized steel plate (70 mm×100 mm) by spray coating to form a coating formation composition layer on the surface of the steel plate.

Finally, the coating formation composition layer was heated at 150° C. for 15 minutes using a drier to form a laminate coating containing a chemical conversion coating and a siliceous coating in this order on the surface of the galvanized steel plate.

### Examples 2 to 10 and Comparative Examples 1 to 4

Components in amounts shown in Table 1 were mixed to prepare coating formation compositions in the same manner as in Example 1. Coatings were then formed.

Lubricants shown below were used.

Lanolin wax: CERACOL609N produced by BYK additives and instruments

Polytetrafluoroethylene wax: Hydrocerf 9174 produced by Shamrock Technologies Inc.

Dimethyl silicone oil: KF96 produced by Shin-Etsu Chemical Co., Ltd.

In the Examples and Comparative Examples using galvanized steel plates subjected to a blackening treatment, the blackening treatment was performed under the following conditions.

### Blackening Treatment

A galvanized steel plate (70 mm×100 mm) was immersed in a blackening treatment solution comprising 0.2 mass % of thioglycolic acid, 5 mass % of phosphoric acid, 1 mass % of iron nitrate nonahydrate, and 93.8 mass % of ion exchange water at 30° C. for 60 seconds.

Metal materials on which laminate coatings were formed in the Examples and Comparative Examples were evaluated as follows.

### Salt Spray Test

A salt spray test was performed in accordance with JIS Z2371 on a galvanized steel plate on which a coating had been formed. White rust and red rust were visually evaluated by measuring the time until the rate of the rust generating area to the sample surface area became 10%.

Table 1 shows the results.

| | | | | | | | |
|---|---|---|---|---|---|---|---|
| Ex. 1 | Ex. 2 | Ex. 3 | Ex. 4 | Ex. 5 | Ex. 6 | Ex. 7 | Ex. 8 |

| | | | |
|---|---|---|---|
| Alkoxysilane | Alkoxysilane | Tetramethoxy silane | 15 |
| oligomer | oligomer | 3-Mercaptopropylsilane | 15 |

| | | |
|---|---|---|
| solution | Propylene glycol | 53.4 |
| (mass %) | Water | 8.3 |
| | Titanium dioctyloxy bis octylene | 8.3 |
| | glycolate | |

| | | | | | | | | | |
|---|---|---|---|---|---|---|---|---|---|
| Metal salt | Chromium sulfate | 15 | | | | | | 0.1 | 30 |
| (parts by mass) | Titanium sulfate | | 10 | | | | | | |
| (per 100 parts by mass of | Zirconium sulfate | | | 12 | | | | | |
| alkoxysilane oligomer) | Strontium nitrate | | | | 18 | | | | |
| | Sodium vanadate | | | | | 8 | | | |
| | Cerium phosphate | | | | | | 20 | | |
| Lubricant | Lanolin wax | | | | | | | 10 | |
| (parts by mass) | Polytetrafluoroethylene | | | | | | | | 5 |
| (per 100 parts by mass of | wax | | | | | | | | |
| alkoxysilane oligomer | Dimethyl silicone | | | | | | | | |
| solution) | | | | | | | | | |

| Colloidal silica (solids content) (parts by mass) | | 5 | 5 | 5 | 5 | 5 | 5 | | |
|---|---|---|---|---|---|---|---|---|---|
| (per 100 parts by mass of | | | | | | | | | |
| alkoxysilane oligomer solution) | | | | | | | | | |
| Blackening treatment | | | | | | | | | |
| Salt spray | White rust generation time (hr.) | 840 | 480 | 480 | 480 | 600 | 600 | 600 | 840 |
| test | Red rust generation time (hr.) | 2640 | 1440 | 1440 | 1440 | 1680 | 1680 | 1680 | 2640 |

| | | | | | |
|---|---|---|---|---|---|
| | | Comp. | Comp. | Comp. | Comp. |
| Ex. 9 | Ex. 10 | Ex. 1 | Ex. 2 | Ex. 3 | Ex. 4 |

| | | | |
|---|---|---|---|
| Alkoxysilane | Alkoxysilane | Tetramethoxy silane | 15 |
| oligomer | oligomer | 3-Mercaptopropylsilane | 15 |

| | | |
|---|---|---|
| solution | Propylene glycol | 53.4 |
| (mass %) | Water | 8.3 |
| | Titanium dioctyloxy bis octylene | 8.3 |
| | glycolate | |

| | | | | | |
|---|---|---|---|---|---|
| Metal salt | Chromium sulfate | 15 | | 0.03 | 50 |
| (parts by mass) | Titanium sulfate | | | | |
| (per 100 parts by mass of | Zirconium sulfate | | | | |
| alkoxysilane oligomer) | Strontium nitrate | | | | |
| | Sodium vanadate | | | | |
| | Cerium phosphate | | 6 | | |
| Lubricant | Lanolin wax | | | | |
| (parts by mass) | Polytetrafluoroethylene | | 5 | | |
| (per 100 parts by mass of | wax | | | | |
| alkoxysilane oligomer | Dimethyl silicone | 1 | | | |
| solution) | | | | | |

| Colloidal silica (solids content) (parts by mass) | | 5 | 5 | | 5 | | 5 |
|---|---|---|---|---|---|---|---|
| (per 100 parts by mass of | | | | | | | |
| alkoxysilane oligomer solution) | | | | | | | |
| Blackening treatment | | ✓ | ✓ | | | | ✓ |
| Salt spray | White rust generation time (hr.) | 600 | 360 | 360 | 360 | 480 | 72 |
| test | Red rust generation time (hr.) | 1440 | 960 | 1080 | 1080 | 1200 | 360 |

The results clearly indicate that in Examples 1 to 10, in which a coating formation composition containing an alkoxysilane oligomer and a metal salt in a solvent was used to form a coating, and the amount of the metal salt was 0.1 to 30 parts by mass per 100 parts by mass of the alkoxysilane oligomer, the white rust generation time and the red rust generation time in the salt spray test were long, ensuring excellent rust prevention properties. This tendency also applied to the case when a galvanized steel plate that was likely to have reduced rust prevention properties as a result of blackening treatment was used. This is clear from the comparison between Comparative Example 4 and Examples 9 and 10.

In contrast, in Comparative Example 1, in which the coating formation composition free of a metal salt was used, the white rust generation time and the red rust generation time were short, indicating that rust prevention properties were reduced.

In Comparative Example 2 with a small amount of metal salt, the white rust generation time and the red rust generation time were short as in Comparative Example 1, indicating that sufficient rust prevention properties were not attained.

In Comparative Example 3 with an excessive amount of metal salt, cracks occurred on a laminate coating including a chemical conversion coating and a siliceous coating in this order on a galvanized steel plate, indicating that rust prevention properties were reduced.

Further, in Comparative Example 4, in which a galvanized steel plate that was likely to have reduced rust prevention properties as a result of blackening treatment was used, the coating formation composition did not contain a metal salt, and thus, rust prevention properties were found to be extremely low.

### FE-SEM Photography

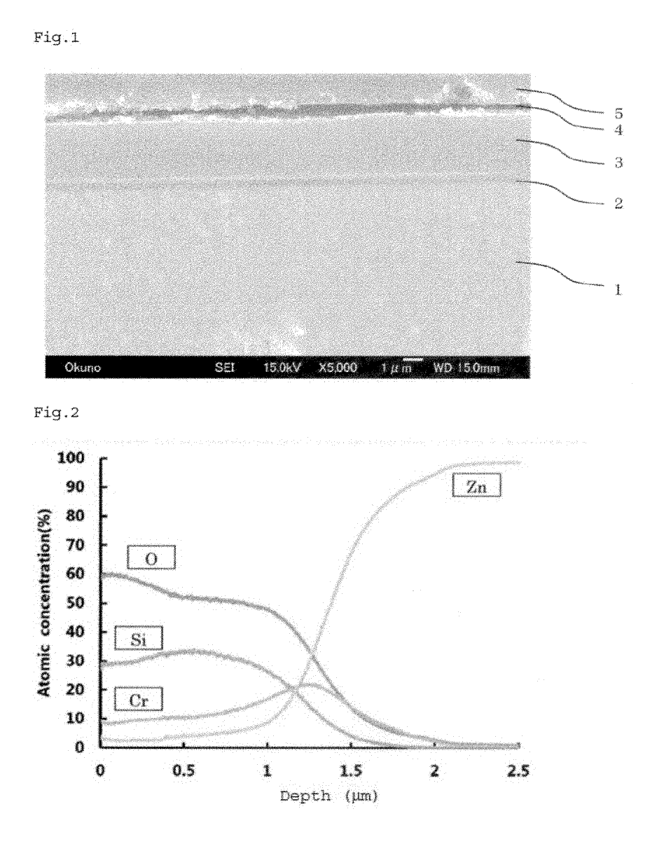

The galvanized steel plate and the laminate coating formed on the plate in Example 1 were cut in the direction perpendicular to the surface of the laminate coating to prepare a sample for photography. The FE-SEM photograph of the section was taken using an FE-SEM photography device (JSM-6335F produced by JEOL Ltd.) at a magnification of 5000 times. During photography, the sample for photography was fixed in a cell using a resin for fixation. FIG. 1 shows the results.

In FIG. 1, a galvanized layer 1, chemical conversion coating 2, siliceous coating 3, space 4, and resin for fixation 5 from the bottom were photographed. It was confirmed from FIG. 1 that a laminate coating including the chemical conversion coating and siliceous coating in this order was formed on the galvanized layer.

### GDS Analysis

The laminate coating prepared in Example 1 was analyzed using a GDS analysis device (GD-Profiler 2 produced by Horiba, Ltd.). FIG. 2 shows the results.

According to FIG. 2, Si and O were detected from the surface of the laminate coating (depth: 0 μm) to a depth about 1 μm from the surface of the laminate coating, indicating that a siliceous coating was formed. From a depth about 1 to about 1.5 μm, Cr was detected, indicating that a chemical conversion coating was formed. Specifically, the results of the GDS analysis also indicate that the laminate coating including the chemical conversion coating and the siliceous coating in this order was formed on the galvanized layer.

### EXPLANATION OF NUMERALS

1. Galvanized layer
2. Chemical conversion coating
3. Siliceous coating
4. Space
5. Resin for fixation

1-9. (canceled)

10. A coating formation composition comprising an alkoxysilane oligomer, a metal salt, and a solvent,
the solvent being water and/or a water-soluble organic solvent,
the metal salt being a salt of at least one metal selected from the group consisting of Cr, Sr, W, Mo, and Ce, and
the metal salt being contained in an amount of 0.1 to 30 parts by mass per 100 parts by mass of the alkoxysilane oligomer.

11. The composition according to claim 10, wherein the metal salt is a metal salt of Cr.

12. The composition according to claim 10, further comprising a lubricant.

13. The composition according to claim 10, further comprising colloidal silica.

14. The composition according to claim 10, further comprising water glass.

15. The composition according to claim 10, wherein the composition is a coating formation composition of a laminate coating including a chemical conversion coating and a siliceous coating.

16. A metal material treatment method comprising:
(1) step 1 of applying a coating formation composition to a surface of a metal material to form a coating formation composition layer, and
(2) step 2 of heating the coating formation composition layer to form on the surface of the metal material a laminate coating including a chemical conversion coating and a siliceous coating in this order from the side of the metal material,
the coating formation composition comprising an alkoxysilane oligomer, a metal salt, and a solvent,
the solvent being water and/or a water-soluble organic solvent,
the metal salt being a salt of at least one metal selected from the group consisting of Cr, Sr, W, Mo, and Ce, and
the metal salt being contained in an amount of 0.1 to 30 parts by mass per 100 parts by mass of the alkoxysilane oligomer.

17. The method according to claim 16, wherein the metal material is zinc or zinc alloy, and the surface of the metal material is treated with a blackening treatment solution without containing chromium, cobalt, or nickel.

18. The method according to claim 16, wherein the coating formation composition is prepared by a sol-gel method.
